(19) United States
(12) Patent Application Publication
(10) Pub. No.: US 2024/0204236 A1
(43) Pub. Date: Jun. 20, 2024

(54) SECONDARY BATTERY

(71) Applicant: MURATA MANUFACTURING CO., LTD., Kyoto (JP)

(72) Inventor: Aya MASHIKO, Kyoto (JP)

(21) Appl. No.: 18/589,660

(22) Filed: Feb. 28, 2024

Related U.S. Application Data
(63) Continuation of application No. PCT/JP2022/037491, filed on Oct. 6, 2022.

(30) Foreign Application Priority Data
Oct. 11, 2021 (JP) 2021-167067

(51) Int. Cl. H01M 10/04; H01M 50/109; H01M 50/153; H01M 50/169; H01M 50/188

(52) U.S. Cl. CPC H01M 10/0427; H01M 10/0431; H01M 50/109; H01M 50/153; H01M 50/169; H01M 50/188

(57) ABSTRACT

A secondary battery includes an outer package member and a battery device. The outer package member has a top part and a bottom part. The top part has a through hole extending in a first direction. The bottom part is disposed to be opposed to the top part in the first direction. The battery device is contained inside the outer package member. The battery device includes a stacked body. The stacked body includes a first electrode and a second electrode, and is wound around an internal space extending in the first direction. The battery device includes an outer wind part and an inner wind part. The outer wind part is sandwiched between the top part and the bottom part in the first direction. The inner wind part is located between the internal space and the outer wind part, and opposed to the through hole in the first direction.

### CROSS REFERENCE TO RELATED APPLICATIONS

The present application is a continuation of PCT patent application no. PCT/JP2022/037491, filed on Oct. 6, 2022, which claims priority to Japanese patent application no. 2021-167067, filed on Oct. 11, 2021, the entire contents are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

For example, a sealed electrical storage device is disclosed including: an electrode body including a positive electrode body, a negative electrode body, and a separator, the positive electrode body and the negative electrode body being stacked or wound with the separator interposed therebetween; and an outer casing containing the electrode body.

### SUMMARY

The present technology relates to a secondary battery.

Consideration has been given in various ways to improve performance of a secondary battery. However, there is room for improvement in terms of the performance of the secondary battery.

It is therefore desirable to provide a secondary battery having higher reliability.

A secondary battery according to an embodiment of the present technology includes an outer package member and a battery device. The outer package member has a top part and a bottom part. The top part has a through hole extending in a first direction. The bottom part is disposed to be opposed to the top part in the first direction. The battery device is contained inside the outer package member. The battery device includes a stacked body. The stacked body includes a first electrode and a second electrode, and is wound around an internal space extending in the first direction. The battery device includes an outer wind part and an inner wind part. The outer wind part is sandwiched between the top part and the bottom part in the first direction. The inner wind part is located between the internal space and the outer wind part, and opposed to the through hole in the first direction.

According to the secondary battery of an embodiment, even if winding loosening occurs due to, for example, application of vibration in the inner wind part of the battery device in which the stacked body including the first electrode and the second electrode is wound, it is possible to prevent the loosened inner wind part from coming into contact with the outer package member. This makes it possible to prevent a short circuit between the first electrode and the second electrode from occurring. Accordingly, the secondary battery achieves higher reliability.

Note that effects of the present technology are not necessarily limited to those described herein and may include any of a series of effects described below in relation to the present technology.

### BRIEF DESCRIPTION OF THE FIGURES

FIG. 1 is a perspective view of a configuration of a secondary battery according to an embodiment of the present technology.

FIG. 2 is a sectional view of the configuration of the secondary battery illustrated in FIG. 1.

FIG. 3 is a sectional view of a configuration of a battery device illustrated in FIG. 2.

FIG. 4 is a perspective view of a configuration of an outer package can to be used in a process of manufacturing the secondary battery.

FIG. 5 is a sectional view of a configuration of a secondary battery of a reference example.

FIG. 6 is a sectional view of a configuration of a secondary battery of an embodiment.

FIG. 7 is a sectional view of a configuration of a secondary battery of an embodiment.

FIG. 8 is a sectional view of a configuration of a secondary battery of an embodiment.

### DETAILED DESCRIPTION

The present technology is described below in further detail including with reference to the drawings.

A description is given first of a secondary battery according to an embodiment of the present technology.

The secondary battery to be described here has a flat and columnar three-dimensional shape, and is commonly referred to as, for example, a coin type or a button type. As will be described later, the secondary battery includes two bottom parts opposed to each other, and a sidewall part located between the two bottom parts. This secondary battery has a height smaller than an outer diameter. The “outer diameter” is a diameter (a maximum diameter) of each of the two bottom parts. The “height” is a distance (a maximum distance) from a surface of one of the bottom parts to a surface of another of the bottom parts. Note that, in the present embodiment, a direction in which one of the bottom parts and another of the bottom parts are joined to each other is assumed to be a height direction Z.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case in which the electrode reactant is lithium. A secondary battery that obtains the battery capacity using insertion and extraction of lithium is what is called a lithium-ion secondary battery. In the lithium-ion secondary battery, lithium is inserted and extracted in an ionic state.

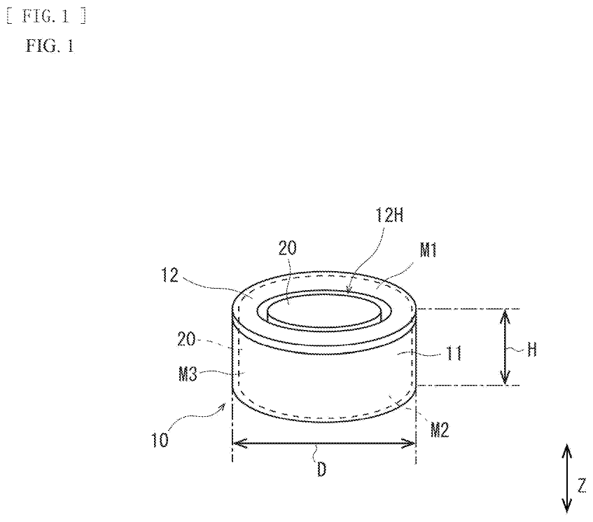

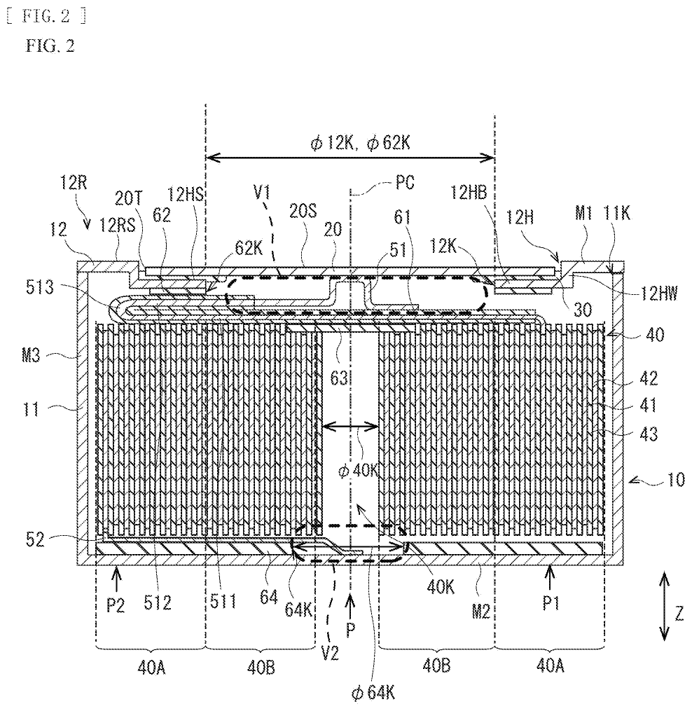

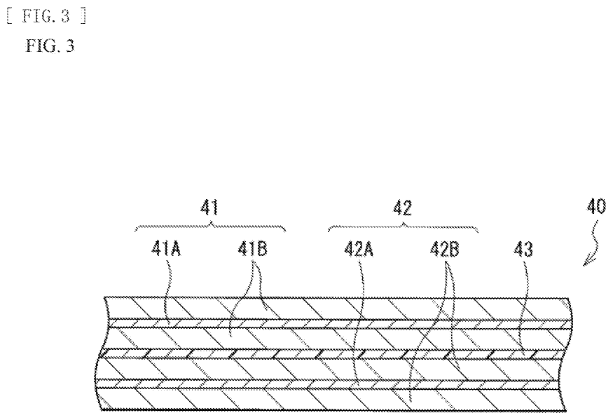

FIG. 1 illustrates a perspective configuration of the secondary battery. FIG. 2 illustrates a sectional configuration of the secondary battery illustrated in FIG. 1. FIG. 3 illustrates a sectional configuration of a battery device 40 illustrated in FIG. 2. Note that FIG. 3 illustrates only a portion of the sectional configuration of the battery device 40 in an enlarged manner.

For convenience, the following description is given with an upper side of each of FIGS. 1 and 2 assumed to be an upper side of the secondary battery, and a lower side of each of FIGS. 1 and 2 assumed to be a lower side of the secondary battery.

The secondary battery to be described here has a three-dimensional shape in which a height H is smaller than an outer diameter D, as illustrated in FIG. 1. In other words, the secondary battery has a flat and columnar three-dimensional shape. Here, the three-dimensional shape of the secondary battery is flat and cylindrical (circular columnar). Note that, in the present embodiment, an up-down direction in a sheet plane in each of FIGS. 1 and 2 is assumed to be the height direction Z. Accordingly, the height H means a dimension, of the secondary battery of the present embodiment, in the height direction Z. The outer diameter D means a dimension, of the secondary battery of the present embodiment, in a direction orthogonal to the height direction Z.

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., D/H, is greater than 1. Although not particularly limited, an upper limit of the ratio D/H is preferably less than or equal to 25.

As illustrated in FIGS. 1 to 3, the secondary battery includes an outer package can 10, an external terminal 20, the battery device 40, and a positive electrode lead 51. Here, the secondary battery further includes a gasket 30, a negative electrode lead 52, a sealant 61, and insulating films 62, 63, and 64.

As illustrated in FIGS. 1 and 2, the outer package can 10 is a hollow outer package member to contain the battery device 40 and other components. The outer package can 10 includes an electrically conductive material.

Here, the outer package can 10 has a flat and circular columnar three-dimensional shape corresponding to the three-dimensional shape of the secondary battery which is flat and circular columnar. Accordingly, the outer package can 10 includes two bottom parts M1 and M2 opposed to each other, and a sidewall part M3 located between the bottom parts M1 and M2. The sidewall part M3 has an upper end part coupled to the bottom part M1, and a lower end part coupled to the bottom part M2. As described above, the outer package can 10 is circular columnar. Thus, the bottom parts M1 and M2 are each circular in plan shape, and a surface of the sidewall part M3 is a convexly curved surface.

The outer package can 10 includes a container part 11 and a cover part 12 that are welded to each other. In other words, an internal space of the outer package can 10 is sealed by the cover part 12 being welded to the container part 11.

The container part 11 is a container member that is to contain the battery device 40 and other components inside, and has a flat and circular columnar shape. The container part 11 has a hollow structure with an upper end part open and a lower end part closed. In other words, the container part 11 has an opening 11K at the upper end part. The opening 11K serves as a passing-through hole through which the battery device 40 is passable in the height direction Z.

The cover part 12 is a substantially disk-shaped cover member that closes the opening 11K of the container part 11, and has a through hole 12K. The through hole 12K has an inner diameter φ12K. The through hole 12K is used as a coupling path for coupling the battery device 40 and the external terminal 20 to each other. An outer edge of the cover part 12 is welded to the opening 11K of the container part 11, as described above. The external terminal 20 is attached to the cover part 12 with the gasket 30 interposed therebetween. That is, the cover part 12 supports the external terminal 20 with the gasket 30 interposed therebetween. The external terminal 20 is so attached to the cover part 12, with the gasket 30 interposed therebetween, as to close the through hole 12K. The external terminal 20 is electrically insulated from the outer package can 10.

In the secondary battery having been completed, the cover part 12 is in a state of having been welded to the container part 11 as described above. The opening 11K has been closed by the cover part 12 as described above. It may thus seem that whether the container part 11 has had the opening 11K is no longer recognizable from an external appearance of the secondary battery.

However, if the cover part 12 is welded to the container part 11, welding marks remain on a surface of the outer package can 10, more specifically, at a boundary part between the container part 11 and the cover part 12. Thus, whether the container part 11 has had the opening 11K is recognizable afterward by checking the presence or absence of the welding marks.

Specifically, the welding marks remaining on the surface of the outer package can 10 indicates that the container part 11 has had the opening 11K. In contrast, no welding marks remaining on the surface of the outer package can 10 indicates that the container part 11 has had no opening 11K.

The cover part 12 is so bent as to partly protrude along the height direction Z toward an inside of the container part 11 and thus forms a recessed part 12H. Specifically, as viewed from outside the outer package can 10, the cover part 12 is shaped to be partly recessed in the height direction Z toward the battery device 40 contained inside the outer package can 10. The recessed part 12H has the through hole 12K extending in the height direction Z, a bottom part 12HB surrounding the through hole 12K along a horizontal plane orthogonal to the height direction Z, and a wall part 12HW provided upright along an outer edge of the bottom part 12HB. A portion of the cover part 12 other than the recessed part 12H is a peripheral part 12R. The peripheral part 12R is provided to surround the recessed part 12H and has an annular shape in the horizontal plane orthogonal to the height direction Z of the secondary battery. The peripheral part 12R is a portion that surrounds a periphery of the recessed part 12H and protrudes away from the battery device 40 along the height direction Z. Accordingly, a surface 12HS of the bottom part 12HB of the recessed part 12H is at a low position in the height direction Z toward the inside of the container part 11 as compared with a surface 12RS of the peripheral part 12R. In other words, a distance between the surface 12HS of the bottom part 12HB of the recessed part 12H and the battery device 40 in the height direction Z is shorter than a distance between the surface 12RS of the peripheral part 12R and the battery device 40 in the height direction Z.

A shape of the recessed part 12H in a plan view, that is, a shape defined by an outer edge of the recessed part 12H when the secondary battery is viewed from above, is not particularly limited. Here, the recessed part 12H has a substantially circular shape in a plan view. Note that an inner diameter and a depth of the recessed part 12H are each not particularly limited and may be set as desired. However, the depth of the recessed part 12H is set to allow a height position of a surface 20S of the external terminal 20 to be lower than a height position of the surface 12RS of the peripheral part 12R, in a state where the external terminal 20 is attached to the recessed part 12H with the gasket 30 interposed therebetween.

As described above, the outer package can 10 is what is called a welded can in which the container part 11 and the cover part 12 that have been physically separate from each other are welded to each other. Thus, the outer package can 10 after the welding is a single member that is physically integral as a whole, and is in a state of being not separable into the container part 11 and the cover part 12 afterward.

The outer package can 10 that is a welded can is different from a crimped can formed by means of crimping processing, and is what is called a crimpless can. A reason for this is to increase a device space volume inside the outer package can 10 and to thereby increase an energy density per unit volume. The “device space volume” refers to a volume (an effective volume) of the internal space of the outer package can 10 available for containing the battery device 40.

Further, the outer package can 10 that is the welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state where two or more members lie over each other and are so combined with each other as to be separable from each other afterward.

Here, the outer package can 10 is electrically conductive. To be more specific, the container part 11 and the cover part 12 are each electrically conductive. The outer package can 10 is electrically coupled to a negative electrode 42 of the battery device 40 via the negative electrode lead 52. Accordingly, the outer package can 10 also serves as an external coupling terminal of the negative electrode 42. It is unnecessary for the secondary battery of the present embodiment to be provided with the external coupling terminal of the negative electrode 42 separate from the outer package can 10, which suppresses a decrease in device space volume resulting from providing the external coupling terminal of the negative electrode 42. As a result, the device space volume increases, and the energy density per unit volume increases accordingly.

Specifically, the outer package can 10 is a metal can that includes any one or more of electrically conductive materials including, without limitation, a metal material and an alloy material. Examples of the electrically conductive material included in the metal can include iron, copper, nickel, stainless steel, an iron alloy, a copper alloy, and a nickel alloy. The stainless steel is not particularly limited in kind, and specific examples thereof include SUS304 and SUS316. Note that the container part 11 and the cover part 12 may include the same material or may include respective different materials.

The cover part 12 is insulated, via the gasket 30, from the external terminal 20 serving as an external coupling terminal of a positive electrode 41. A reason for this is to prevent contact, or a short circuit, between the outer package can 10 that is the external coupling terminal of the negative electrode 42 and the external terminal 20 that is the external coupling terminal of the positive electrode 41.

As illustrated in FIGS. 1 and 2, the external terminal 20 is a coupling terminal to be coupled to electronic equipment when the secondary battery is mounted on the electronic equipment. As described above, the external terminal 20 is attached to the cover part 12 of the outer package can 10 to be supported by the cover part 12.

Here, the external terminal 20 is coupled to the positive electrode 41 of the battery device 40 via the positive electrode lead 51. The external terminal 20 thus also serves as the external coupling terminal of the positive electrode 41. Accordingly, upon use of the secondary battery, the secondary battery is coupled to electronic equipment via the external terminal 20 serving as the external coupling terminal of the positive electrode 41 and the outer package can 10 serving as the external coupling terminal of the negative electrode 42. This allows the electronic equipment to operate with use of the secondary battery as a power source.

The external terminal 20 is a flat and substantially plate-shaped member that spreads along a horizontal plane orthogonal to the height direction Z of the secondary battery, and is disposed inside the recessed part 12H with the gasket 30 interposed between the external terminal 20 and the recessed part 12H. The external terminal 20 is insulated from the cover part 12 via the gasket 30. Here, as illustrated in FIG. 2, a height H1 of the surface 20S of the external terminal 20 is low in the height direction Z toward the battery device 40 as compared with a height H2 of the surface 12RS of the peripheral part 12R of the outer package can 10 (H1<H2). In other words, the external terminal 20 is contained inside the recessed part 12H in such a manner that the surface 20S, which is an upper end of the external terminal 20, is recessed toward the battery device 40 as compared with the surface 12RS. Specifically, as illustrated in FIG. 2, the surface 20S is lower than the surface 12RS in the height direction Z by a height DF. The height H1 of the surface 20S of the external terminal 20 is, where the secondary battery is disposed in a horizontal location with the height direction Z of the secondary battery being a vertical direction, a dimension in the vertical direction from an outer surface M2S, which is a bottom surface of the secondary battery, of the bottom part M2 of the outer package can 10 to the surface 20S, of the external terminal 20, on a side opposite to the battery device 40. This similarly applies to the height H2 of the surface 12RS of the peripheral part 12R of the outer package can 10. That is, the height H2 of the surface 12RS is, where the secondary battery is disposed in the horizontal location with the height direction Z of the secondary battery being the vertical direction, a dimension in the vertical direction from the outer surface M2S of the bottom part M2 of the outer package can 10 to the surface 12RS, of the peripheral part 12R, on the side opposite to the battery device 40. In the secondary battery of the present embodiment, the height H of the secondary battery is reduced as compared with a case where the external terminal 20 protrudes above the cover part 12. This increases the energy density per unit volume of the secondary battery. This also makes it possible to prevent a short circuit between the outer package can 10 and the external terminal 20 from being caused by another electrically conductive member. Further, in the present embodiment, a peripheral portion of the external terminal 20 overlaps the bottom part 12HB of the recessed part 12H in the height direction Z. Owing to the external terminal 20 and the cover part 12 having an overlap portion, it is possible to improve mechanical strength of the secondary battery as a whole. Here, a length, of the overlap portion of the external terminal 20 and the peripheral portion, along a horizontal plane orthogonal to the height direction Z is preferably greater than a thickness of the external terminal 20 and greater than a thickness of the bottom part 12HB.

Note that the external terminal 20 has an outer diameter smaller than the inner diameter of the recessed part 12H. The external terminal 20 is thus spaced from the cover part 12 in a periphery of the external terminal 20. Accordingly, the gasket 30 is disposed in only a portion of a region between the external terminal 20 and the cover part 12 (the recessed part 12H). More specifically, the gasket 30 is disposed only at a location where the external terminal 20 and the cover part 12 would be in contact with each other if it were not for the gasket 30. However, the gasket 30 is preferably also provided between an inner wall face of the wall part 12HW of the recessed part 12H and an outer edge 20T of the external terminal 20. Further, the cover part 12 and the external terminal 20 are preferably stuck to each other by the gasket 30.

Further, the external terminal 20 includes any one or more of electrically conductive materials including, without limitation, a metal material and an alloy material. Examples of the electrically conductive materials include aluminum and an aluminum alloy. However, the external terminal 20 may include a cladding material. The cladding material includes an aluminum layer and a nickel layer disposed in this order from a side closer to the gasket 30. In the cladding material, the aluminum layer and the nickel layer are roll-bonded to each other.

The gasket 30 is an insulating member disposed between the outer package can 10 (the cover part 12) and the external terminal 20, as illustrated in FIG. 2. The external terminal 20 is fixed to the cover part 12 with the gasket 30 interposed between the external terminal 20 and the cover part 12. The gasket 30 is ring-shaped in a plan view and has a through hole at a location corresponding to the through hole 12K. The gasket 30 includes any one or more of insulating materials including, without limitation, a polymer compound having an insulating property. The insulating materials include a resin such as polypropylene or polyethylene.

A range of placement of the gasket 30 is not particularly limited, may be chosen as desired. Here, the gasket 30 is disposed in a gap between a top surface of the cover part 12 and a bottom surface of the external terminal 20, inside the recessed part 12H. However, as described above, the gasket 30 is preferably also provided between the inner wall face of the wall part 12HW of the recessed part 12H and the outer edge 20T of the external terminal 20. Further, the cover part 12 and the external terminal 20 are preferably stuck to each other by the gasket 30.

The battery device 40 is a power generation device that causes charging and discharging reactions to proceed. As illustrated in FIGS. 2 and 3, the battery device 40 is contained inside the outer package can 10. The battery device 40 includes the positive electrode 41 and the negative electrode 42. Here, the battery device 40 further includes a separator 43 and an electrolytic solution. The electrolytic solution is a liquid electrolyte, and is not illustrated.

A center line PC illustrated in FIG. 2 is a line segment corresponding to a center of the battery device 40 in a direction along the outer diameter D of the secondary battery (the outer package can 10). More specifically, a position P of the center line PC corresponds to a position of the center of the battery device 40.

The battery device 40 is what is called a wound electrode body. More specifically, in the battery device 40, the positive electrode 41 and the negative electrode 42 are stacked on each other with the separator 43 interposed between the positive electrode 41 and the negative electrode 42. In addition, the stack of the positive electrode 41, the negative electrode 42, and the separator 43 is wound. The positive electrode 41 and the negative electrode 42 are wound, remaining in a state of being opposed to each other with the separator 43 interposed between the positive electrode 41 and the negative electrode 42. As a result, a winding center space 40K serving as an internal space is present at the center of the battery device 40. The winding center space 40K has an inner diameter φ40K. The battery device 40 includes an outer wind part 40A and an inner wind part 40B. The inner wind part 40B is located on an inner side of the outer wind part 40A. The outer wind part 40A is a portion sandwiched between the cover part 12 and the bottom part M2 in the height direction Z. In contrast, the inner wind part 40B is a portion located between the winding center space 40K and the outer wind part 40A, and opposed to the through hole 12K in the height direction Z. Accordingly, the inner diameter φ40K of the winding center space 40K is smaller than the inner diameter φ12K of the through hole 12K, and the winding center space 40K is so present as to be in a region onto which the through hole 12K is projectable in the height direction Z.

Here, the positive electrode 41, the negative electrode 42, and the separator 43 are so wound that the separator 43 is disposed in each of an outermost wind of the wound electrode body and an innermost wind of the wound electrode body. Respective numbers of winds of the positive electrode 41, the negative electrode 42, and the separator 43 are not particularly limited, and may be chosen as desired.

The battery device 40 has a three-dimensional shape based on the three-dimensional shape of the outer package can 10. Specifically, the battery device 40 has a flat and circular columnar three-dimensional shape. This helps to prevent what is called a dead space, more specifically, a gap between the outer package can 10 and the battery device 40, from easily resulting when the battery device 40 is placed inside the outer package can 10, as compared with a case where the battery device 40 has a three-dimensional shape different from the three-dimensional shape of the outer package can 10. This allows for efficient use of the internal space of the outer package can 10. As a result, the device space volume increases, and the energy density per unit volume of the secondary battery increases accordingly.

The positive electrode 41 is a first electrode to be used to cause the charging and discharging reactions to proceed. As illustrated in FIG. 3, the positive electrode 41 includes a positive electrode current collector 41A and a positive electrode active material layer 41B.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

The positive electrode active material layer 41B is provided on each of the two opposed surfaces of the positive electrode current collector 41A. The positive electrode active material layer 41B includes any one or more of positive electrode active materials into which lithium is insertable and from which lithium is extractable. Note that the positive electrode active material layer 41B may be provided only on one of the two opposed surfaces of the positive electrode current collector 41A. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode active material includes a lithium compound. The term “lithium compound” is a generic term for a compound that includes lithium as a constituent element. More specifically, the lithium compound is a compound that includes lithium and one or more transition metal elements as constituent elements. A reason for this is that a high energy density is obtainable. Note that the lithium compound may further include any one or more of other elements (excluding lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes any one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 42 is a second electrode to be used to cause the charging and discharging reactions to proceed. As illustrated in FIG. 3, the negative electrode 42 includes a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

The negative electrode active material layer 42B is provided on each of the two opposed surfaces of the negative electrode current collector 42A. The negative electrode active material layer 42B includes any one or more of negative electrode active materials into which lithium is insertable and from which lithium is extractable. Note that the negative electrode active material layer 42B may be provided only on one of the two opposed surfaces of the negative electrode current collector 42A. The negative electrode active material layer 42B may further include other materials including, without limitation, a negative electrode binder and a negative electrode conductor. Details of the negative electrode binder are similar to the details of the positive electrode binder. Details of the negative electrode conductor are similar to the details of the positive electrode conductor. A method of forming the negative electrode active material layer 42B is not particularly limited, and specifically includes any one or more of methods including, without limitation, a coating method, a vapor-phase method, a liquid-phase method, a thermal spraying method, and a firing (sintering) method.

The negative electrode active material includes a carbon material, a metal-based material, or both. A reason for this is that a high energy density is obtainable. Examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, the negative electrode 42 has a height greater than a height of the positive electrode 41. More specifically, the negative electrode 42 protrudes above the positive electrode 41, and protrudes below the positive electrode 41. A reason for this is to prevent precipitation of lithium extracted from the positive electrode 41. The “height” is a dimension corresponding to the height H of the secondary battery described above, that is, a dimension in the up-down direction in each of FIGS. 1 and 2. The definition of the height described here applies also to the following.

The separator 43 is an insulating porous film interposed between the positive electrode 41 and the negative electrode 42, as illustrated in FIGS. 2 and 3. The separator 43 allows lithium ions to pass through the separator 43 and prevents a short circuit between the positive electrode 41 and the negative electrode 42. The separator 43 includes a polymer compound such as polyethylene.

Here, the separator 43 has a height greater than the height of the negative electrode 42. More specifically, the separator 43 preferably protrudes above the negative electrode 42 and protrudes below the negative electrode 42. A reason for this is to insulate the positive electrode lead 51 from the negative electrode 42 by using the separator 43, as will be described later.

The electrolytic solution includes a solvent and an electrolyte salt. The positive electrode 41, the negative electrode 42, and the separator 43 are each impregnated with the electrolytic solution. The solvent includes any one or more of non-aqueous solvents (organic solvents) including, without limitation, a carbonic-acid-ester-based compound, a carboxylic-acid-ester-based compound, and a lactone-based compound. An electrolytic solution that includes any of the non-aqueous solvents is what is called a non-aqueous electrolytic solution. The electrolyte salt includes any one or more of light metal salts including, without limitation, a lithium salt.

As illustrated in FIG. 2, the positive electrode lead 51 is contained inside the outer package can 10. The positive electrode lead 51 is a coupling wiring line coupled to each of the positive electrode 41 and the external terminal 20. The secondary battery illustrated in FIG. 2 includes one positive electrode lead 51. Note that the secondary battery may include two or more positive electrode leads 51.

The positive electrode lead 51 is coupled to an upper end part of the positive electrode 41. Specifically, the positive electrode lead 51 is coupled to an upper end part of the positive electrode current collector 41A. Further, the positive electrode lead 51 is coupled to the bottom surface of the external terminal 20 through the through hole 12K provided in the cover part 12. A method of coupling the positive electrode lead 51 is not particularly limited, and specifically includes any one or more of welding methods including, without limitation, a resistance welding method and a laser welding method. The details of the welding methods described here apply also to the following.

A portion of the positive electrode lead 51 is electrically insulated from each of the cover part 12 of the outer package can 10 and the negative electrode 42 of the battery device 40, and is sandwiched by the cover part 12 and the battery device 40 in the height direction of the secondary battery. As illustrated in FIG. 2, the positive electrode lead 51 includes a first part 511, a second part 512, and a turning part 513. The first part 511 and the second part 512 each extend along a horizontal plane orthogonal to the height direction Z of the secondary battery. Further, the first part 511 and the second part 512 overlap each other in the height direction Z of the secondary battery, with the sealant 61 interposed between the first part 511 and the second part 512. The turning part 513 is so curved as to couple the first part 511 and the second part 512 to each other.

The first part 511 and the second part 512 are sandwiched between the battery device 40 and a protruding part 12P of the cover part 12 in the height direction Z of the secondary battery.

In this way, the portion of the positive electrode lead 51 is held by the cover part 12 and the battery device 40 by extending along each of a bottom surface of the cover part 12 and a top surface of the battery device 40. This allows the positive electrode lead 51 to be fixed inside the outer package can 10. By preventing the positive electrode lead 51 from easily moving even if the secondary battery undergoes an external force such as vibration or impact, the positive electrode lead 51 is prevented from being easily damaged. Examples of damage to the positive electrode lead 51 include cracking of the positive electrode lead 51, breakage of the positive electrode lead 51, and detachment of the positive electrode lead 51 from the positive electrode 41.

More specifically, the wording “a portion of the positive electrode lead 51 is sandwiched by the outer package can 10 and the battery device 40” is intended to mean that the positive electrode lead 51 is held by the outer package can 10 and the battery device 40 from above and below while being insulated from each of the outer package can 10 and the battery device 40, and that the positive electrode lead 51 is thus in a state of being not easily movable inside the outer package can 10 even if the secondary battery undergoes an external force such as vibration or impact. The state where the positive electrode lead 51 is not easily movable inside the outer package can 10 exactly indicates that the battery device 40 is also in the state of being not easily movable inside the outer package can 10. This helps to also suppress a defect of the battery device 40, i.e., the wound electrode body, such as winding deformation when the secondary battery undergoes vibration or impact.

Note that the positive electrode lead 51 preferably digs into the battery device 40 due to pressing by the battery device 40. More specifically, the positive electrode lead 51 preferably digs into an upper end part of the separator 43 because of the height of the separator 43 being greater than the height of each of the positive electrode 41 and the negative electrode 42 as described above. In such a case, a recessed part is formed in the upper end part of the separator 43 due to pressing by the positive electrode lead 51. A portion or all of the positive electrode lead 51 is received in the recessed part, which allows the positive electrode lead 51 to be held by the separator 43. A reason for this is to further prevent the positive electrode lead 51 from easily moving inside the outer package can 10, and to thereby further prevent the positive electrode lead 51 from being easily damaged.

Here, as described above, the cover part 12 includes the protruding part 12P, and a portion of the positive electrode lead 51 is sandwiched by the protruding part 12P and the battery device 40. More specifically, the portion of the positive electrode lead 51 is held by the protruding part 12P and the battery device 40 by extending along each of a bottom surface of the protruding part 12P and the top surface of the battery device 40. The protruding part 12P helps to hold the positive electrode lead 51 more easily. This further prevents the positive electrode lead 51 from being easily damaged.

Further, the portion of the positive electrode lead 51 is insulated from the cover part 12 and the negative electrode 42 via each of the separator 43, the sealant 61, and the insulating films 62 and 63.

Specifically, as described above, the height of the separator 43 is greater than the height of the negative electrode 42. Accordingly, the portion of the positive electrode lead 51 is separated from the negative electrode 42 via the separator 43, and is thus insulated from the negative electrode 42 via the separator 43. A reason for this is to prevent a short circuit between the positive electrode lead 51 and the negative electrode 42.

Further, the positive electrode lead 51 is covered at a periphery thereof by the sealant 61 having an insulating property. The portion of the positive electrode lead 51 is thus insulated from each of the cover part 12 and the negative electrode 42 via the sealant 61. A reason for this is to prevent a short circuit between the positive electrode lead 51 and the cover part 12, and to also prevent a short circuit between the positive electrode lead 51 and the negative electrode 42.

Further, the insulating film 62 is disposed between the cover part 12 and the positive electrode lead 51. The portion of the positive electrode lead 51 is thus insulated from the cover part 12 via the insulating film 62. A reason for this is to prevent a short circuit between the positive electrode lead 51 and the cover part 12.

Furthermore, the insulating film 63 is disposed between the battery device 40 and the positive electrode lead 51. The portion of the positive electrode lead 51 is thus insulated from the negative electrode 42 via the insulating film 63. A reason for this is to prevent a short circuit between the positive electrode lead 51 and the negative electrode 42.

Details of a material included in the positive electrode lead 51 are similar to the details of the material included in the positive electrode current collector 41A. Note that the material included in the positive electrode lead 51 and the material included in the positive electrode current collector 41A may be the same or different from each other.

Here, the positive electrode lead 51 is coupled to the positive electrode 41 in a region on a front side relative to the center line PC, i.e., a region on a right side relative to the center line PC in FIG. 2. In order to be coupled to the external terminal 20, the positive electrode lead 51 includes the turning part 513 in the middle of extension to the external terminal 20. The turning part 513 is present in a region on a back side relative to the center line PC, i.e., a region on a left side relative to the center line PC in FIG. 2. The positive electrode lead 51 includes the first part 511 that corresponds to a part from a location where the positive electrode lead 51 is coupled to the positive electrode 41, through the center position P, to the turning part 513. The first part 511 extends along the top surface of the battery device 40 in a direction orthogonal to the height direction Z. In addition, the positive electrode lead 51 includes the second part 512 that corresponds to a part in the middle of extension from the turning part 513 to a location where the positive electrode lead 51 is coupled to the external terminal 20. The second part 512 extends along the top surface of the battery device 40 in the direction orthogonal to the height direction Z in such a manner as to be laid over the first part 511. As described above, the portion of the positive electrode lead 51 is sandwiched by the cover part 12 and the battery device 40 and extends toward the external terminal 20, in both the region on the front side relative to the center line PC and the region on the back side relative to the center line PC.

Here, as is apparent from FIG. 2, “the region on the front side relative to the center line PC” is, where the battery device 40 is divided into two regions with respect to the center line PC in a direction along the outer diameter D, one region in which the location where the positive electrode lead 51 is coupled to the positive electrode 41 is present. In FIG. 2, “the region on the front side relative to the center line PC” is the region on the right side relative to the center line PC. In contrast, as is apparent from FIG. 2, “the region on the back side relative to the center line PC” is the other region of the two regions, and is the region on the left side relative to the center line PC in FIG. 2. In other words, “the region on the back side relative to the center line PC” is, where the battery device 40 is divided into the two regions with respect to the center line PC in the direction along the outer diameter D, the other region in which the location where the positive electrode lead 51 is coupled to the positive electrode 41 is absent.

A position of coupling of the positive electrode lead 51 to the positive electrode 41 is not particularly limited, and may be chosen as desired. In particular, the positive electrode lead 51 is preferably coupled to the positive electrode 41 on an inner side of winding of the positive electrode 41 relative to an outermost wind of the positive electrode 41. A reason for this is that corrosion of the outer package can 10 caused by creeping up of the electrolytic solution is suppressed unlike when the positive electrode lead 51 is coupled to the positive electrode 41 in the outermost wind of the positive electrode 41. The “creeping up of the electrolytic solution” refers to a phenomenon in which, when the positive electrode lead 51 is disposed in proximity to an inner wall surface of the outer package can 10, the electrolytic solution in the battery device 40 creeps up along the positive electrode lead 51 to reach the inner wall surface of the outer package can 10. The electrolytic solution coming into contact with the outer package can 10 as a result of the “creeping up of the electrolytic solution” causes a phenomenon in which the outer package can 10 dissolves or changes in color.

Here, in a region between the positive electrode 41 and the external terminal 20, the positive electrode lead 51 is turned up once or more and thus lies over itself once or more. The number of times the positive electrode lead 51 is to be turned up is not particularly limited as long as it is once or more. The wording “the positive electrode lead 51 is turned up” means that the extending direction of the positive electrode lead 51 changes at an angle greater than 90° in the middle of the positive electrode lead 51. The positive electrode lead 51 preferably has, at a location where the positive electrode lead 51 is turned up, a curved shape rather than the bent shape, as with the turning part 513. Further, although FIG. 2 illustrates an example in which the positive electrode lead 51 includes one turning part 513, the positive electrode lead 51 may include multiple turning parts 513.

The positive electrode lead 51 is turned up at the turning part 513 in the middle of extension from the positive electrode 41 to the external terminal 20. Specifically, as illustrated in FIG. 2, the first part 511 extends from a first position P1 to a second position P2 in a horizontal plane orthogonal to the height direction of the secondary battery. The first position P1 is other than the center position P of the outer package can 10. The second position P2 is on a side opposite to the first position P1 as viewed from the center position. The second part 512 extends from the second position P2 toward the center position P. In the positive electrode lead 51, an overlap portion of the first part 511 and the second part 512 is a surplus portion. It can thus be said that the positive electrode lead 51 has a length margin in a longitudinal direction of the positive electrode lead 51.

This provides room to change orientation of the cover part 12 relative to the container part 11 when forming the outer package can 10 by using the container part 11 and the cover part 12 in a process of manufacturing the secondary battery, as will be described later. Further, when the secondary battery undergoes an external force such as vibration or impact, the length margin of the positive electrode lead 51 is usable to mitigate the external force, thereby helping to prevent the positive electrode lead 51 from being easily damaged. Furthermore, the length margin of the positive electrode lead 51 is usable to change the position of coupling of the positive electrode lead 51 to the positive electrode 41 to a desired position without changing the positive electrode lead 51 in length.

In this case, the length (an entire length including the length margin) of the positive electrode lead 51 is not particularly limited, and may be chosen as desired. The length of the positive electrode lead 51 is preferably greater than or equal to half the outer diameter D of the outer package can 10, in particular. A reason for this is to ensure that the length of the positive electrode lead 51 has a length margin allowing for raising the cover part 12 relative to the container part 11, and to thereby make it easier to raise the cover part 12 relative to the container part 11.

A range of coupling of the positive electrode lead 51 to the external terminal 20 is not particularly limited. It is preferable that the range of coupling of the positive electrode lead 51 to the external terminal 20 be wide enough for the positive electrode lead 51 to be prevented from easily becoming detached from the external terminal 20 and be narrow enough to allow for the length margin of the positive electrode lead 51, in particular. A reason why the range of coupling of the positive electrode lead 51 to the external terminal 20 is preferably narrow enough is that a sufficiently large length margin of the positive electrode lead 51 is achievable because a portion of the positive electrode lead 51 not coupled to the external terminal 20 serves as the length margin.

Note that the positive electrode lead 51 is provided separately from the positive electrode current collector 41A. However, the positive electrode lead 51 may be physically continuous with the positive electrode current collector 41A and may thus be provided integrally with the positive electrode current collector 41A.

As illustrated in FIG. 2, the negative electrode lead 52 is contained inside the outer package can 10. The negative electrode lead 52 is coupled to each of the negative electrode 42 and the outer package can 10 (the container part 11). Here, the secondary battery includes one negative electrode lead 52. However, the secondary battery may include two or more negative electrode leads 52.

The negative electrode lead 52 is coupled to a lower end part of the negative electrode 42, more specifically, a lower end part of the negative electrode current collector 42A. Further, the negative electrode lead 52 is coupled to a bottom surface of the container part 11. Details of a method of coupling the negative electrode lead 52 are similar to the details of the method of coupling the positive electrode lead 51.

Details of a material included in the negative electrode lead 52 are similar to the details of the material included in the negative electrode current collector 42A. Note that the material included in the negative electrode lead 52 and the material included in the negative electrode current collector 42A may be the same or different from each other.

A position of coupling of the negative electrode lead 52 to the negative electrode 42 is not particularly limited, and may be chosen as desired. Here, the negative electrode lead 52 is coupled to an outermost wind portion of the negative electrode 42 included in the wound electrode body.

Note that the negative electrode lead 52 is provided separately from the negative electrode current collector 42A. However, the negative electrode lead 52 may be physically continuous with the negative electrode current collector 42A and may thus be provided integrally with the negative electrode current collector 42A.

The sealant 61 is a first insulating member covering the periphery of the positive electrode lead 51, as illustrated in FIG. 2. The sealant 61 includes two insulating tapes each being attached to corresponding one of a front surface and a back surface of the positive electrode lead 51. Here, to allow the positive electrode lead 51 to be coupled to each of the positive electrode 41 and the external terminal 20, the sealant 61 covers the periphery of a portion in the middle of the positive electrode lead 51. Note that a structure of the sealant 61 is not limited to a tape-shaped structure, and the sealant 61 may have a tube-shaped structure, for example.

The sealant 61 includes any one or more of insulating materials including, without limitation, a polymer compound having an insulating property. Examples of the insulating materials include polyimide.

The insulating film 62 is a first insulator disposed between the cover part 12 and the positive electrode lead 51 in the height direction Z, as illustrated in FIG. 2. Here, the insulating film 62 is ring-shaped in a plan view and has an opening 62K at a location corresponding to the through hole 12K in the height direction Z. The opening 62K has an inner diameter φ62K. The inner diameter φ12K of the through hole 12K and the inner diameter φ62K of the opening 62K are each preferably larger than the inner diameter φ40K of the winding center space 40K.

Here, the insulating film 62 may have an unillustrated adhesive layer on one surface, and may thus be adhered to either the cover part 12 or the positive electrode lead 51 via the adhesive layer. Alternatively, the insulating film 62 may have respective adhesive layers on both surfaces, and may thus be adhered to both the cover part 12 and the positive electrode lead 51 via the respective adhesive layers.

The insulating film 62 may include any one or more of insulating materials including, without limitation, a polymer compound having an insulating property. Examples of the insulating materials to be included in the insulating film 62 include polyimide.

The insulating film 63 is a third insulating member disposed between the battery device 40 and the positive electrode lead 51, as illustrated in FIG. 2. Here, the insulating film 63 is flat plate-shaped in a plan view. The insulating film 63 is disposed to block the winding center space 40K and to cover the battery device 40 around the winding center space 40K.

Details of a material included in the insulating film 63 are similar to the details of the material included in the insulating film 62. Note that the material included in the insulating film 63 and the material included in the insulating film 62 may be the same or different from each other.

The insulating film 64 is a second insulator provided between the bottom part M2 and the battery device 40 in the height direction Z, as illustrated in FIG. 2. Here, the insulating film 64 is ring-shaped in a plan view and has an opening 64K at a location corresponding to the through hole 12K in the height direction Z. The opening 64K has an inner diameter φ64K. The inner diameter φ64K of the opening 64K is preferably larger than the inner diameter φ40K of the winding center space 40K. Accordingly, a portion of the inner wind part 40B including an innermost wind portion of the battery device 40 is provided at a position corresponding to the opening 64K in the height direction Z.

Details of a material included in the insulating film 64 are similar to the details of the material included in the insulating film 62. Note that the material included in the insulating film 64 and the material included in the insulating film 62 may be the same or different from each other. The material included in the insulating film 64 and the material included in the insulating film 63 may also be the same or different from each other.

Note that the secondary battery may further include one or more other components.

Specifically, the secondary battery includes a safety valve mechanism. The safety valve mechanism is to cut off electrical coupling between the outer package can 10 and the battery device 40 if an internal pressure of the outer package can 10 reaches a certain level or higher. Examples of a factor that causes the internal pressure of the outer package can 10 to reach the certain level or higher include the occurrence of a short circuit in the secondary battery and heating of the secondary battery from outside. Although a placement location of the safety valve mechanism is not particularly limited, the safety valve mechanism is preferably placed on either the bottom part M1 or the bottom part M2, and more preferably, on the bottom part M2 to which no external terminal 20 is attached, in particular.

Further, the secondary battery may include an insulator between the outer package can 10 and the battery device 40. The insulator includes any one or more of materials including, without limitation, an insulating film and an insulating sheet, and prevents a short circuit between the outer package can 10 and the battery device 40. A range of placement of the insulator is not particularly limited, and may be chosen as desired.

Note that the outer package can 10 is provided with a cleavage valve. The cleavage valve cleaves to release the internal pressure of the outer package can 10 when the internal pressure reaches a certain level or higher. A placement location of the cleavage valve is not particularly limited. However, the cleavage valve is preferably placed on either the bottom part M1 or the bottom part M2, and more preferably, on the bottom part M2, in particular, as with the placement location of the safety valve mechanism described above.

Upon charging of the secondary battery, in the battery device 40, lithium is extracted from the positive electrode 41, and the extracted lithium is inserted into the negative electrode 42 through the electrolytic solution. Upon discharging of the secondary battery, in the battery device 40, lithium is extracted from the negative electrode 42, and the extracted lithium is inserted into the positive electrode 41 through the electrolytic solution. Upon the charging and the discharging, lithium is inserted and extracted in an ionic state.

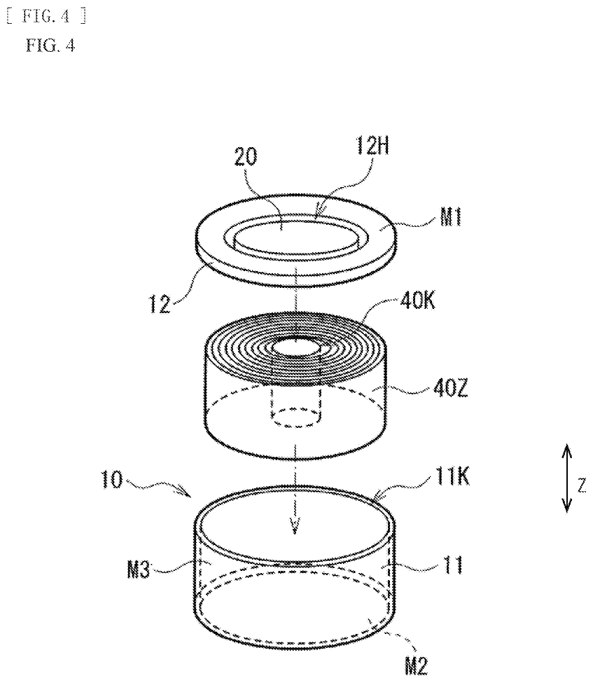

FIG. 4 illustrates a perspective configuration of the outer package can 10 to be used in the process of manufacturing the secondary battery, and corresponds to FIG. 1.

FIG. 4 illustrates a state where the cover part 12 is separate from the container part 11 before the cover part 12 is welded to the container part 11.

In the following description, where appropriate, FIGS. 1 to 3 described already will be referred to in conjunction with FIG. 4.

Here, as illustrated in FIG. 4, the container part 11 and the cover part 12 that are physically separate from each other are prepared to form the outer package can 10. The container part 11 is a substantially bowl-shaped member in which the bottom part M2 and the sidewall part M3 are integrated with each other, and has the opening 11K. The cover part 12 is a substantially plate-shaped member corresponding to the bottom part M1. The external terminal 20 is attached in advance to the recessed part 12H provided in the cover part 12, with the gasket 30 interposed between the external terminal 20 and the recessed part 12H.

Alternatively, the bottom part M2 and the sidewall part M3 that are physically separate from each other may be prepared and the container part 11 may be formed by welding the sidewall part M3 to the bottom part M2.

First, the positive electrode active material and other materials including, without limitation, the positive electrode binder and the positive electrode conductor are mixed with each other to thereby produce a positive electrode mixture. Thereafter, the positive electrode mixture thus produced is put into a solvent such as an organic solvent to thereby prepare a positive electrode mixture slurry in paste form. Thereafter, the positive electrode mixture slurry is applied on the two opposed surfaces of the positive electrode current collector 41A to thereby form the positive electrode active material layers 41B. Lastly, the positive electrode active material layers 41B are compression-molded by means of, for example, a roll pressing machine. In this case, the positive electrode active material layers 41B may be heated. The positive electrode active material layers 41B may be compression-molded multiple times. In this manner, the positive electrode 41 is fabricated.

The negative electrode 42 is fabricated by a procedure similar to the fabrication procedure of the positive electrode 41. Specifically, a negative electrode mixture, which is obtained by mixing the negative electrode active material and other materials including, without limitation, the negative electrode binder and the negative electrode conductor with each other, is put into an organic solvent to thereby prepare a negative electrode mixture slurry in paste form, following which the negative electrode mixture slurry is applied on the two opposed surfaces of the negative electrode current collector 42A to thereby form the negative electrode active material layers 42B. Thereafter, the negative electrode active material layers 42B are compression-molded by means of, for example, a roll pressing machine. In this manner, the negative electrode 42 is fabricated.

The electrolyte salt is put into the solvent. The electrolyte salt is thereby dispersed or dissolved in the solvent. Thus, the electrolytic solution is prepared.

First, by means of a welding method such as a resistance welding method, the positive electrode lead 51 covered at the periphery thereof by the sealant 61 is coupled to the positive electrode 41 (the positive electrode current collector 41A), and the negative electrode lead 52 is coupled to the negative electrode 42 (the negative electrode current collector 42A).

Thereafter, the positive electrode 41 and the negative electrode 42 are stacked on each other with the separator 43 interposed between the positive electrode 41 and the negative electrode 42, following which the stack including the positive electrode 41, the negative electrode 42, and the separator 43 is wound to thereby fabricate a wound body 40Z, as illustrated in FIG. 4. The wound body 40Z has a configuration similar to the configuration of the battery device 40 except that the positive electrode 41, the negative electrode 42, and the separator 43 are each unimpregnated with the electrolytic solution. Note that FIG. 4 omits the illustration of each of the positive electrode lead 51 and the negative electrode lead 52.

Thereafter, the wound body 40Z to which the positive electrode lead 51 and the negative electrode lead 52 are each coupled is placed into the container part 11 through the opening 11K. In this case, the negative electrode lead 52 is coupled to the container part 11 by means of a welding method such as a resistance welding method. Thereafter, the insulating film 63 is placed on the wound body 40Z.

Thereafter, the cover part 12 to which the external terminal 20 is attached in advance with the gasket 30 being interposed between the cover part 12 and the external terminal 20 and on which the insulating film 62 is provided in advance is prepared, following which the positive electrode lead 51 is coupled to the external terminal 20 through the through hole 12K by means of a welding method such as a resistance welding method.

As a result, the wound body 40Z (the positive electrode 41) contained inside the container part 11 and the external terminal 20 attached to the cover part 12 are coupled to each other via the positive electrode lead 51.

Thereafter, the electrolytic solution is injected into the container part 11 through the opening 11K. In this case, because the opening 11K is not closed by the cover part 12 as described above, the electrolytic solution is easily injectable into the container part 11 through the opening 11K even if the battery device 40 and the external terminal 20 are coupled to each other via the positive electrode lead 51. The wound body 40Z including the positive electrode 41, the negative electrode 42, and the separator 43 is thereby impregnated with the electrolytic solution. Thus, the battery device 40, i.e., the wound electrode body, is fabricated.

Thereafter, the cover part 12 is brought down into close proximity to the container part 11 to thereby close the opening 11K with the cover part 12, following which the cover part 12 is welded to the container part 11 by means of a welding method such as a laser welding method. In this case, as illustrated in FIG. 2, a portion of the positive electrode lead 51 is caused to be sandwiched between the cover part 12 and the battery device 40, and the turning part 513 that is curved is formed on a front side relative to the location where the positive electrode lead 51 is coupled to the external terminal 20. In this manner, the outer package can 10 is formed, and the battery device 40 and other components are contained inside the outer package can 10. Assembly of the secondary battery is thus completed.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of, for example, the negative electrode 42. This brings the secondary battery into an electrochemically stable state. The secondary battery is thus completed.

As described above, according to the secondary battery of the present embodiment, the inner wind part 40B of the battery device 40 is opposed to the through hole 12K of the cover part 12 in the height direction Z. In other words, the inner diameter φ40K of the winding center space 40K is smaller than the inner diameter φ12K of the through hole 12K, and the winding center space 40K is so present as to be in a region onto which the through hole 12K is projectable in the height direction Z. This ensures a space V1 between the inner wind part 40B of the battery device 40 and the external terminal 20 as illustrated in FIG. 2.

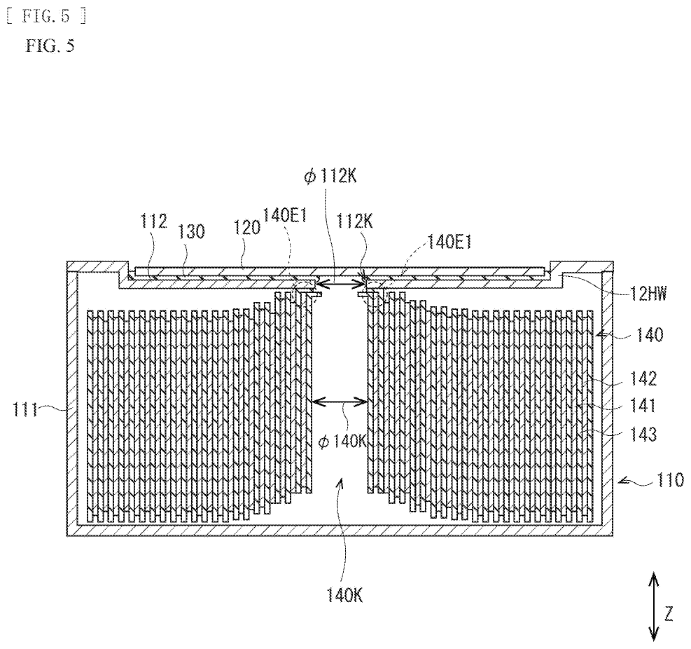

FIG. 5 is an enlarged sectional schematic view of a portion of a secondary battery of a reference example. FIG. 5 illustrates, out of components included in the secondary battery of the reference example, only a container part 111, a cover part 112, an external terminal 120, a gasket 130, and a battery device 140. The cover part 112 has a through hole 112K extending in the height direction Z. The battery device 140 includes a stacked body including a positive electrode 141, a separator 143, and a negative electrode 142, and the stacked body is wound around a winding center space 140K serving as an internal space. The winding center space 140K has an inner diameter φ140K. An inner diameter φ112K of the through hole 112K is smaller than or equal to the inner diameter φ140K of the winding center space 140K. In the secondary battery including the battery device 140 having a winding structure as illustrated in FIG. 5, application of vibration from an outside can generally cause winding loosening in the battery device 140, which causes an innermost wind portion of the battery device 140 to protrude upward to rise. In such a case, an upper end 140E1 of the innermost wind portion of the battery device 140 can be pressed against a bottom surface of the cover part 112. Thus, the positive electrode and the negative electrode can be crushed or bent in the vicinity of the upper end 140E1. As a result, a short circuit between the positive electrode and the negative electrode can occur.

In contrast, the secondary battery of the present embodiment ensures the space V1 between the inner wind part 40B of the battery device 40 and the external terminal 20, as described above. Accordingly, even if the winding loosening as illustrated in FIG. 5 occurs in the battery device 40 due to, for example, vibration, it is possible to prevent an upper end of a portion of the inner wind part 40B, e.g., the upper end of several winds including the innermost wind, from being pushed against the bottom surface of the cover part 12 or the bottom surface of the external terminal 20. It is therefore possible to prevent a short circuit between the positive electrode and the negative electrode.

In addition, in the secondary battery according to the present embodiment, the insulating film 64 is provided between the battery device 40 and the bottom part M2 of the container part 11. The insulating film 64 has the opening 64K at the location corresponding to the through hole 12K in the height direction Z. Here, the inner diameter φ64K of the opening 64K is larger than the inner diameter φ40K of the winding center space 40K. This ensures a space V2 between a portion of the inner wind part 40B including the innermost wind portion of the battery device 40 and the bottom part M2, as illustrated in FIG. 2. Accordingly, even if the winding loosening occurs in the battery device 40 due to, for example, vibration, it is possible to prevent a lower end of a portion of the inner wind part 40B, e.g., the lower end of several winds including the innermost wind, from being pushed against a top surface of the bottom part M2. It is therefore possible to prevent a short circuit between the positive electrode and the negative electrode.

Further, the recessed part 12H has the through hole 12K extending in the height direction Z, and the bottom part 12HB surrounding the through hole 12K along the horizontal plane orthogonal to the height direction Z. A portion of the external terminal 20 overlaps the bottom part 12HB of the recessed part 12H in the height direction Z. As described above, the secondary battery of the present embodiment includes the overlap portion of the external terminal 20 and the cover part 12. This makes it possible to improve mechanical strength of the secondary battery as a whole. In particular, the length, of the overlap portion of the external terminal 20 and the bottom part 12HB, along the horizontal plane orthogonal to the height direction Z is greater than the thickness of the external terminal 20 and is greater than the thickness of the bottom part 12HB. This further improves the mechanical strength.

Further, in the secondary battery according to the present embodiment, the gasket 30 including an insulating resin is provided between the inner wall face of the recessed part 12H and the outer edge 20T of the external terminal 20. This makes it possible to prevent a foreign material from entering a gap between the inner wall face of the recessed part 12H and the outer edge 20T of the external terminal 20, and to prevent a short circuit between the cover part 12 and the external terminal 20.

Further, in the secondary battery according to the present embodiment, the cover part 12 and the external terminal 20 are stuck to each other by the gasket 30 including an insulating resin. It is thus possible to increase mechanical strength against vibration. This makes it possible to prevent a short circuit caused by entry of a foreign material into the gap between the recessed part 12H and the external terminal 20.

Further, in the secondary battery according to the present embodiment, the cover part 12 is provided with the recessed part 12H, and the external terminal 20 is disposed in the recessed part 12H. This makes it possible to reduce a height dimension of the secondary battery while ensuring a battery capacity.

Further, in the secondary battery according to the present embodiment, the turning part 513 is located at a position corresponding to the peripheral portion 12R of the cover part 12 in the Z-axis direction, and the first part 511 and the second part 512 extend in a radial direction of the secondary battery from the center position of the secondary battery toward the peripheral part 12R. Specifically, the first part 511 extends from the first position P1 to the second position P2 in a horizontal plane orthogonal to the height direction Z of the secondary battery. The first position P1 is other than the center position P of the outer package can 10, and the second position P2 is on the side opposite to the first position P1 as viewed from the center position P. The second part 512 extends from the second position P2 toward the center position. The overlap portion of the first part 511 and the second part 512 is sandwiched and held by the protruding part 12P and the battery device 40. This helps to ensure that the first part 511 is in contact with the battery device 40 over a larger area with the sealant 61 interposed between the first part 511 and the battery device 40, and that the second part 512 is in contact with the recessed part 12H over a larger area directly or with the sealant 61 interposed between the second part 512 and the recessed part 12H. Accordingly, movements of the positive electrode lead 51 and the battery device 40 inside the outer package can 10 are sufficiently limited. This helps to prevent a defect, such as damage to the positive electrode lead 51 or winding deformation of the battery device 40, from easily occurring even when the secondary battery undergoes impact or vibration. The secondary battery according to the present embodiment thus makes it possible to achieve superior physical durability.

In particular, the above-described action and effects are achievable by the secondary battery according to the present embodiment for reasons described below.

The secondary battery according to the present embodiment, which is referred to as, for example, the coin type or the button type, that is, the secondary battery having a flat and columnar three-dimensional shape, includes the external terminal 20 that is small in size and serves as the external coupling terminal of the positive electrode 41, as is apparent from FIGS. 1 and 2. In this case, the external terminal 20 having the small size results in a small coupling area of the positive electrode lead 51 to the external terminal 20. Accordingly, it is necessary to sufficiently fix the positive electrode lead 51 inside the outer package can 10 in order to maintain the state where the external terminal 20 and the positive electrode lead 51 are electrically coupled to each other.

In this regard, in the secondary battery according to the present embodiment, movement of the positive electrode lead 51 inside the outer package can 10 is sufficiently suppressed. Accordingly, even if the coupling area of the positive electrode lead 51 to the external terminal 20 is small, it is highly unlikely that the positive electrode lead 51 will become detached from the external terminal 20 or be broken. The secondary battery according to the present embodiment thus makes it possible to favorably maintain the state where the external terminal 20 and the positive electrode lead 51 are electrically coupled to each other, even when the secondary battery undergoes an external force such as vibration or impact. It is therefore possible, with the secondary battery according to the present embodiment, to achieve high physical durability even if the secondary battery is reduced in size.

Further, in the secondary battery according to the present embodiment including the small-sized external terminal 20 serving as the external coupling terminal of the positive electrode 41, the cover part 12 of the outer package can 10 serving as the external coupling terminal of the negative electrode 42 is disposed in proximity to the external terminal 20, as is apparent from FIG. 2. In other words, the cover part 12 and the external terminal 20 which are two external coupling terminals having respective polarities different from each other are located close to each other. Accordingly, to prevent a short circuit between the cover part 12 and the external terminal 20, it is desirable that the coupling area of the positive electrode lead 51 to the external terminal 20 be sufficiently made small and that the positive electrode lead 51 be located sufficiently away from the cover part 12.

In this regard, in the secondary battery according to the present embodiment, movement of the positive electrode lead 51 inside the outer package can 10 is sufficiently suppressed. Accordingly, even if the coupling area of the positive electrode lead 51 to the external terminal 20 is small, it is highly unlikely that the positive electrode lead 51 will become detached from the external terminal 20 or be broken. The secondary battery according to the present embodiment thus makes it possible to favorably maintain the state where the external terminal 20 and the positive electrode lead 51 are electrically coupled to each other, even when the secondary battery undergoes an external force such as vibration or impact. It is therefore possible, with the secondary battery according to the present embodiment, to achieve high physical durability while preventing a short circuit between the cover part 12 and the external terminal 20, even if the secondary battery is reduced in size.

Further, the height of the separator 43 having an insulating property may be greater than the height of the negative electrode 42, and a portion of the positive electrode lead 51 may be insulated from the negative electrode 42 via the separator 43. In such a case, a short circuit between the positive electrode lead 51 and the negative electrode 42 is prevented, and accordingly, it is possible to achieve higher reliability.

In this case, the positive electrode 41 and the negative electrode 42 may be wound, being opposed to each other with the separator 43 interposed between the positive electrode 41 and the negative electrode 42. In addition, the positive electrode lead 51 may be coupled to the positive electrode 41 on the inner side of the winding of the positive electrode 41 relative to the outermost wind of the positive electrode 41. In such a case, corrosion of the outer package can 10 resulting from creeping up of the electrolytic solution is suppressed. Accordingly, it is possible to achieve further higher reliability.

Further, the sealant 61 may cover the periphery of the positive electrode lead 51, and a portion of the positive electrode lead 51 may be insulated from each of the outer package can 10 and the negative electrode 42 via the sealant 61. In such a case, a short circuit between the positive electrode lead 51 and the outer package can 10 is prevented, and a short circuit between the positive electrode lead 51 and the negative electrode 42 is also prevented. Accordingly, it is possible to achieve higher reliability.

In this case, in particular, covering the periphery of the positive electrode lead 51 with the sealant 61 provides the following effects. When the positive electrode lead 51 is sandwiched by the outer package can 10 and the battery device 40 with the sealant 61 interposed between the positive electrode lead 51 and each of the outer package can 10 and the battery device 40, a grip force is generated between the outer package can 10 and the sealant 61, and also between the battery device 40 and the sealant 61. As a result, it becomes easier for the positive electrode lead 51 to be held by the outer package can 10 and the battery device 40 with the help of the grip force supplied to the positive electrode lead 51 via the sealant 61. As a result, the positive electrode lead 51 is insulated from the outer package can 10 and the negative electrode 42 via the sealant 61. In addition, it becomes further easier for the positive electrode lead 51 to be fixed inside the outer package can 10 with the help of the sealant 61. This makes it possible to achieve further higher physical durability.

Further, the insulating film 62 may be disposed between the outer package can 10 and the positive electrode lead 51, and a portion of the positive electrode lead 51 may be insulated from the outer package can 10 via the insulating film 62. In such a case, a short circuit between the positive electrode lead 51 and the outer package can 10 is prevented. Accordingly, it is possible to achieve higher reliability.

Further, the insulating film 63 may be disposed between the battery device 40 and the positive electrode lead 51, and a portion of the positive electrode lead 51 may be insulated from the negative electrode 42 via the insulating film 63. In such a case, a short circuit between the positive electrode lead 51 and the negative electrode 42 is prevented. Accordingly, it is possible to achieve higher reliability.

Further, the outer package can 10 includes the container part 11 and the cover part 12 that are welded to each other, and the positive electrode lead 51 is turned up once or more, which provides a length margin of the positive electrode lead 51. It thus becomes possible to raise the cover part 12 relative to the container part 11 in the process of manufacturing the secondary battery, particularly in a process of forming the outer package can 10. This allows for easy injection of the electrolytic solution, and furthermore, allows for changing the position of coupling of the positive electrode lead 51 to the positive electrode 41 as desired. Accordingly, it is possible to achieve higher easiness of manufacture.

Further, the secondary battery may have a flat and columnar shape, that is, the secondary battery may be a secondary battery that is referred to as, for example, the coin type or the button type. In such a case, the positive electrode lead 51 is prevented from being easily damaged even in a small-sized secondary battery that is highly constrained in terms of size. Accordingly, it is possible to achieve higher effects in terms of physical durability.

Further, the secondary battery may be a lithium-ion secondary battery. In such a case, it is possible to stably obtain a sufficient battery capacity through the use of insertion and extraction of lithium.

The configuration of the secondary battery described above is appropriately modifiable, including as described below according to an embodiment. Note that any two or more of the following series of modifications may be combined with each other.

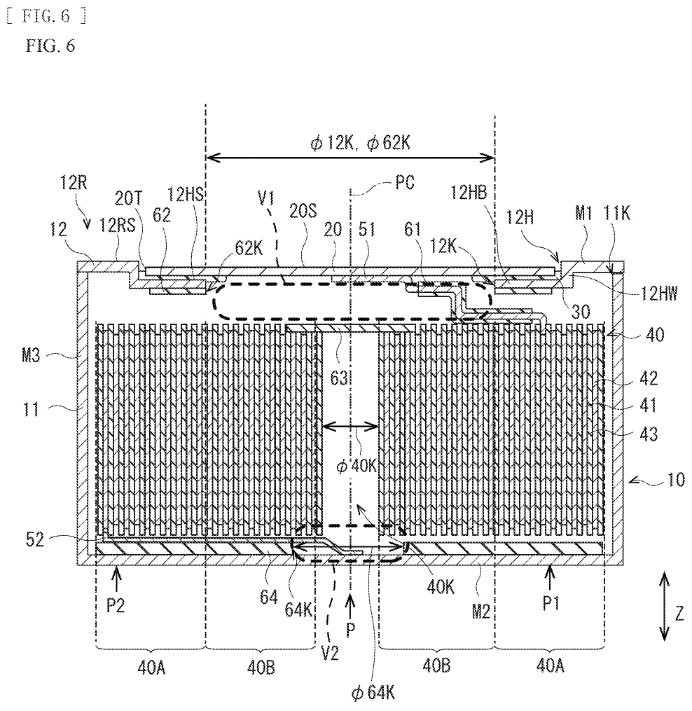

FIG. 2 illustrates a case where the positive electrode lead 51 includes the first part 511 and the second part 512 that are so provided as to overlap each other in the height direction Z, and the turning part 513 coupling the first part 511 and the second part 512; however, the present disclosure is not limited thereto. Specifically, as in a secondary battery of an embodiment illustrated in FIG. 6, the positive electrode lead 51 may have a structure that includes neither an overlap portion nor a turning part. A configuration of the secondary battery illustrated in FIG. 6 has substantially the same configuration as the configuration of the secondary battery of the embodiment illustrated in FIG. 2, except that the positive electrode lead 51 includes neither the overlap portion nor the turning part.

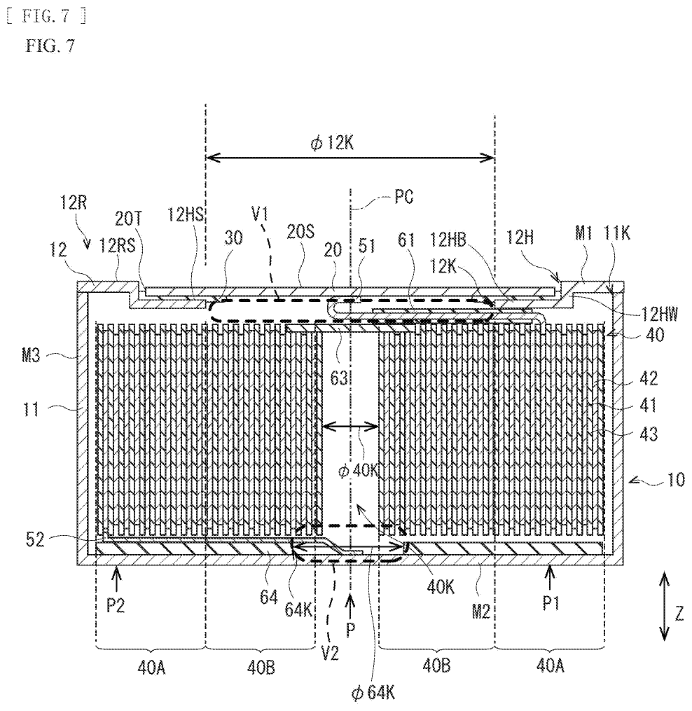

The secondary battery also secures the space V1. Accordingly, it is possible to achieve effects similar to the effects of the secondary battery according to the above-described embodiment. FIG. 7 illustrates a sectional configuration of a secondary battery of an embodiment. A layout of the positive electrode lead 51 of the secondary battery of the disclosure is not limited to that of the secondary battery illustrated in FIG. 2 or FIG. 6. As in the secondary battery illustrated in FIG. 7, the positive electrode lead 51 may have a turning part at a position corresponding to the winding center space 40K in the height direction Z, for example. The secondary battery also secures the space V1. Accordingly, it is possible to achieve effects similar to the effects of the secondary battery according to the above-described embodiment.

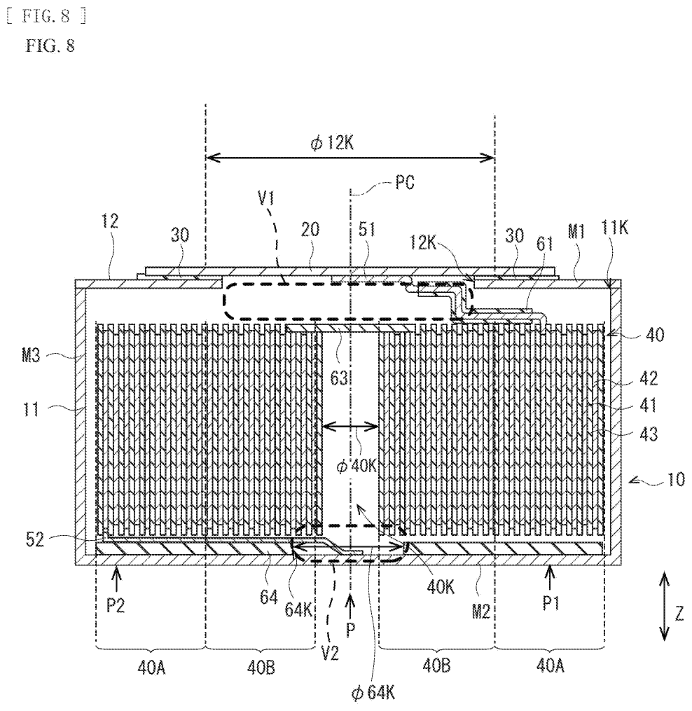

FIG. 8 illustrates a sectional configuration of a secondary battery of Modification 3 of the above-described embodiment. In the secondary battery of FIG. 2, the cover part 12 includes the recessed part 12H. However, as illustrated in FIG. 8, the cover part 12 may include no recessed part 12H.

Even in the secondary battery including the cover part 12 with no recessed part 12H, the inner wind part 40B of the battery device 40 is opposed to the through hole 12K of the cover part 12 in the height direction Z. That is, the inner diameter φ40K of the winding center space 40K is smaller than the inner diameter φ12K of the through hole 12K, and the winding center space 40K is so present as to be in a region onto which the through hole 12K is projectable in the height direction Z. This ensures the space V1 between the inner wind part 40B of the battery device 40 and the external terminal 20, as illustrated in FIG. 8. Accordingly, it is possible to achieve effects similar to the effects of the secondary battery according to the above-described embodiment.

Although the present technology has been described above with reference to one or more embodiments, the configuration of the present technology is not limited to the configurations described herein, and is modifiable in a variety of ways.

Specifically, although the description has been given of the case where the outer package can is a welded can (a crimpless can), the outer package can is not particularly limited in configuration, and may be a crimped can which has undergone crimping processing. In the crimped can, a container part and a cover part separate from each other are crimped to each other with a gasket interposed between the container part and the cover part.

Further, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the technology are therefore not limited to those described herein. Accordingly, the technology may achieve any other effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an outer package member having a top part and a bottom part, the top part having a through hole extending in a first direction, the bottom part being disposed to be opposed to the top part in the first direction; and
a battery device contained inside the outer package member, the battery device including a stacked body, the stacked body including a first electrode and a second electrode and being wound around an internal space extending in the first direction, wherein
the battery device includes an outer wind part and an inner wind part, the outer wind part being sandwiched between the top part and the bottom part in the first direction, the inner wind part being located between the internal space and the outer wind part and opposed to the through hole in the first direction.

2. The secondary battery according to claim 1, further comprising
a first insulator provided between the top part and the battery device in the first direction, wherein
the first insulator has a first opening provided at a position corresponding to the through hole in the first direction.

3. The secondary battery according to claim 2, wherein an inner diameter of the through hole and an inner diameter of the first opening are each larger than an inner diameter of the internal space.

4. The secondary battery according to claim 1, further comprising
a second insulator provided between the bottom part and the battery device in the first direction, wherein
the second insulator has a second opening provided at a position corresponding to the through hole in the first direction.

5. The secondary battery according to claim 4, wherein an inner diameter of the through hole and an inner diameter of the second opening are each larger than an inner diameter of the internal space.

6. The secondary battery according to claim 1, further comprising
an external terminal attached to the top part to close the through hole of the top part, with an insulating member interposed between the external terminal and the top part.

7. The secondary battery according to claim 1, wherein the outer package member includes a container and a cover part, the container having a passing-through hole through which the battery device is passable in the first direction and being configured to contain the battery device through the passing-through hole, the cover part serving as the top part closing the passing-through hole.

8. The secondary battery according to claim 7, wherein an outer edge of the cover part is coupled to the passing-through hole of the container by welding.

9. The secondary battery according to claim 1, wherein
the top part of the outer package member has a recessed part recessed in the first direction toward the battery device, and
the through hole is provided in the recessed part.

10. The secondary battery according to claim 1, wherein an end of a current collector in a center region is lower than an end of a current collector outside of the center region.

11. The secondary battery according to claim 10, wherein an insulating film is disposed on the end of the current collector in the center region.

12. The secondary battery according to claim 11, wherein an external terminal, a tab, the insulating film and a lower part are arranged in order, in a thickness direction, and wherein a gap is between the insulating film and the tab.

13. A secondary battery comprising:
an outer package member having a top part and a bottom part, the top part having a through hole extending in a first direction, the bottom part being disposed to be opposed to the top part in the first direction; and
a battery device contained inside the outer package member, the battery device including a stacked body, the stacked body including a first electrode and a second electrode and being wound around an internal space extending in the first direction, wherein
an inner diameter of the internal space is smaller than an inner diameter of the through hole, and
the internal space is present in a region onto which the through hole is projectable in the first direction.
